(19) United States
(12) Patent Application Publication
(10) Pub. No.: US 2015/0019174 A1
(43) Pub. Date: Jan. 15, 2015

(54) ONTOLOGY DRIVEN BUILDING AUDIT SYSTEM

(71) Applicant: Honeywell International Inc., Morristown, NJ (US)

(72) Inventors: Liana Maria Kiff, Minneapolis, MN (US); Girija Parthasarathy, Maple Grove, MN (US); Henry Chen, Beijing (CN); Hao Bai, Beijing (CN); Muli Liu, Beijing (CN)

(21) Appl. No.: 13/937,701

(22) Filed: Jul. 9, 2013

(51) Int. Cl. G06F 17/50

(52) U.S. Cl. CPC G06F 17/5004
USPC 703/1

(57) ABSTRACT

A method includes representing a building structure and component systems using a structural set of ontologies to create a building ontology, representing audit tasks and audit processes using an audit ontology, and presenting an ordered set of audit tasks to an auditor using the structural set of ontologies and the audit ontology, enabling the auditor to complete an audit process and populate data about instances in the building ontology representing a specific building.

### BACKGROUND

Auditing buildings is becoming more and more critical in many domains. Many different types of audits are performed on buildings, such as energy audits, HVAC audits, security audits, asset audits, safety audits, compliance audits, and other types of audits. Energy audits can be very important, as the buildings sector consumes over 40 percent of the total primary energy and are therefore large emitters of greenhouse gases. It has been estimated that since 1973, energy efficiency improvements have helped save over 50 percent of the energy consumed in the United States compared to the business-as-usual scenario without development and implementation of such measures. A building energy audit is crucial to identifying such measures to save even more energy.

Tools to assist in the many different types of audits have generally been based on the particular data needed to conduct the audit. This has resulted in such tools utilizing different data structures and workflows, that are inflexible. Typical data structures are hierarchical in nature, and reports basically answer a list of questions answered and organized by space and equipment. Common audit tools consist of spreadsheets and paper which are not flexible, and are difficult to use to collect data needed to audit a building.

### SUMMARY

A method includes representing a building structure and component systems using a structural set of ontologies to create a building ontology, representing audit tasks and audit processes using an audit ontology, and presenting an ordered set of audit tasks to an auditor using the structural set of ontologies and the audit ontology, enabling the auditor to complete an audit process and populate data about instances in the building ontology representing a specific building.

A computer readable storage device having instructions for causing a computer to perform a method, the method including representing a building structure and component systems using a structural set of ontologies to create a building ontology, representing audit tasks and audit processes using an audit ontology, and presenting an ordered set of audit tasks to an auditor using the structural set of ontologies and the audit ontology, enabling the auditor to complete an audit process and populate data about instances in the building ontology representing a specific building.

In a further embodiment, a system includes a building ontology representing a building structure and component systems using a structural set of ontologies stored on a computer readable storage device. An audit ontology represents audit tasks and audit processes stored on a computer readable storage device. A processor is coupled to access the audit ontology, and has code for executing an audit tool. The audit tool is stored on a computer readable storage device and includes code to present an ordered set of audit tasks to an auditor using the structural set of ontologies and the audit ontology, enabling the auditor to complete an audit process and populate data about instances in the building ontology representing a specific building.

### BRIEF DESCRIPTION OF THE DRAWINGS

FIG. 1 is a block diagram of an audit system according to an example embodiment.

FIG. 2 is a diagram representation of a building ontology for use in an audit system according to an example embodiment.

FIG. 3 is a diagram representation of an equipment ontology according to an example embodiment.

FIGS. 4A, 4B, 4C, 4D, and 4E are diagrams representing an audit ontology according to an example embodiment.

FIG. 5 is a diagram illustrating input conversion for an audit system ontology according to an example embodiment.

FIG. 6 is a diagram illustrating output conversion for an audit system ontology according to an example embodiment.

FIG. 7 is a diagram illustrating a data collection methodology for an audit system according to an example embodiment.

FIG. 8 is a diagram of a data collection interface for an HVAC audit according to an example embodiment.

FIG. 9 is a diagram of a data collection interface for a light system audit according to an example embodiment.

FIGS. 10A and 10B are a diagram illustrating data collection for an HVAC audit interface according to an example embodiment.

FIGS. 11A and 11B illustrate the creation of ontology instances for a building and a floor respectively according to an example embodiment.

FIG. 12 illustrates the creation of a sibling instance for a building concept according to an example embodiment.

FIG. 13 illustrates the creation of a sibling instance for a piece of equipment concept according to an example embodiment.

FIG. 14 is a block diagram of a computer system for implementing one or more methods, algorithms, and systems according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

In various embodiments, audit related data from multiple data sources is collected and converted to create instances of objects conforming to a comprehensive building ontology of elements in a building. This ontology and the instances support a tool using a workflow of audit tasks to enable a guided physical audit, and on which data, reports and analytics can be performed.

A generic approach is used for data structure definition, defining an audit data model for an ontology driven building audit system. The system provides for ease of data management, including import and export of different data among different sources. For example, some data, like space, equipment, etc., can be downstreamed from EBI (Honeywell's Enterprise Building Integrator), CP-O (Honeywell's ComfortPoint Open), etc., and some data can be exported to an analysis tool, like energy analysis by expert or some simulation tool, like DOE2. The audit data is easily recognizable.

In one embodiment, the building ontology, and the instance data about a specific building and a specific set of audit tasks, may be used to provide a structured interface that the user may employ to walk through the building in a systematic fashion, and to systematically locate, positively identify, and complete data collection for each asset or “condition” being audited. For example, a compliance audit may require that the auditor measure clearance around the landing of a staircase, or the height of a handrail.

In another instance, the end user (auditor) may be required to identify the location of a smoke detector, confirm the identity (serial number), confirm the performance (responds appropriately to canned smoke) and then record the test results (signaling) provided by the device during the test. An audit process would ensure that the auditor, such as a human user, has completed the audit for every known device, and/or has completed necessary measurements for every identified space in the auditable building.

In the case of energy audits, similar but not identical processes may be used to identify the functioning state of equipment (fans work, dampers are not stuck), and to confirm the type and configuration of the device identified in that location (that the device has not been switched out for a new device with different characteristics.) Or, to identify that new devices have been installed that were never previously recorded and audited.

The auditing system workflow can provide a completeness measure for the audit, for previously known devices and spaces. This provides the end user with a guide showing how complete the audit is, and how much more space or how many more devices are still to be audited. This is a measure of compliance to the prescribed audit procedure, and provides value; particularly in situation where the audit is regulated by some governing body, such as OSHA.

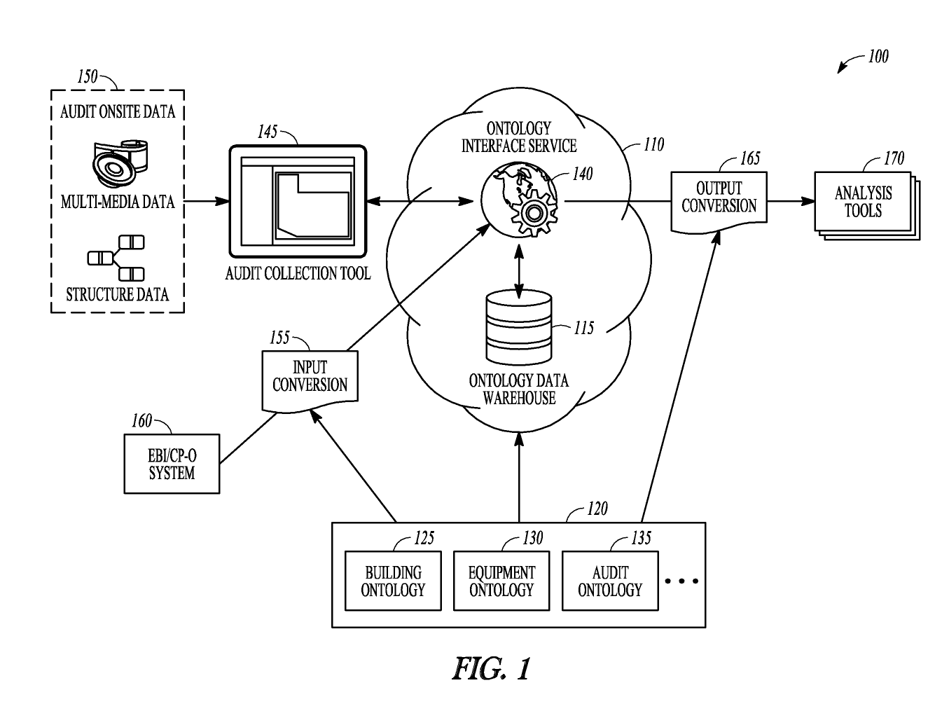

FIG. 1 is a block diagram of an audit system 100. The audit system includes a computer system 110 with access to an ontology database 115, which may be integrated with the computer system 110 or accessed via a network in some embodiments. Database 115 may be a relational database of any type, including an in memory database in various embodiments. In one embodiment, a data ontology 120 is defined, identifying audit data and relationships between the data. The ontology 120 may be represented in a selected format, such as resource description framework (RDF). The RDF data is then stored on the database 115, which may be located on a network, such as the cloud to be easily accessible by multiple people involved in the audits. The ontology may be used to drive the audit process. A service may be provided to access the data from a database that may reside on a storage device such as a local or remote storage device for example. In one example ontology, several layers of ontology are defined, such as a building ontology 125, equipment ontology 130, and audit ontology 135. An ontology interface service 140 may be used to access the ontology 120. In one embodiment, the ontology interface service 140 provides a set of application interfaces to move data in and out of the database 115, and to provide an interface for queries to the database.

Once the ontology 120 is defined, audit data may be managed via the ontology interface service 140 based on the ontology. An audit data collection tool 145 based on the ontology provides specific data collection mechanisms for specific audit data 150, including multi-media data, structure data and other audit onsite data. This allows data collection to be simplified in some embodiments based on the corresponding ontology definition. A heuristic collection portal may be used to facilitate users creating an instance of audit data according to the ontology definition. Concepts and relationship in the ontology may be selected to convert 155 downstream the audit data from existing data sources 160, such as EBI, CP-O, and others. The data from the different sources may be synchronized, including existing building management systems and walk-through audits. Input conversion 155 from different sources may be used to perform data reconciliation. Output conversion 165 may also be performed for different usage, such as generating reports, energy analysis, and others. Concepts and relationships in the ontology may be selected to upstream into other systems, applications, and analysis tools 170 such as an energy analysis system.

In one embodiment, the audit system may be used to define multiple ontologies for different audit tasks reusing the same building ontology. Different ontologies may be assembled into different audit systems. Instances from an existing system, such as CP-O, EBI, etc., may be reused. A conversion mechanism may be provided to map the data among various applications. In one embodiment, the audit system provides the ability to input audit data and create a data instance from different data source, such as existing building management system and walk-through audit. The system may also provide the ability to convert the audit data stored by RDF to different data structure for different applications, such as energy analysis tool, energy audit tool, etc. The ontology may be adapted to assist the audit data collection. The system may also automatically generate relationships between different types of instances according to the ontology. A heuristics data collection portal may be provided for the user to create the instance of the audit data.

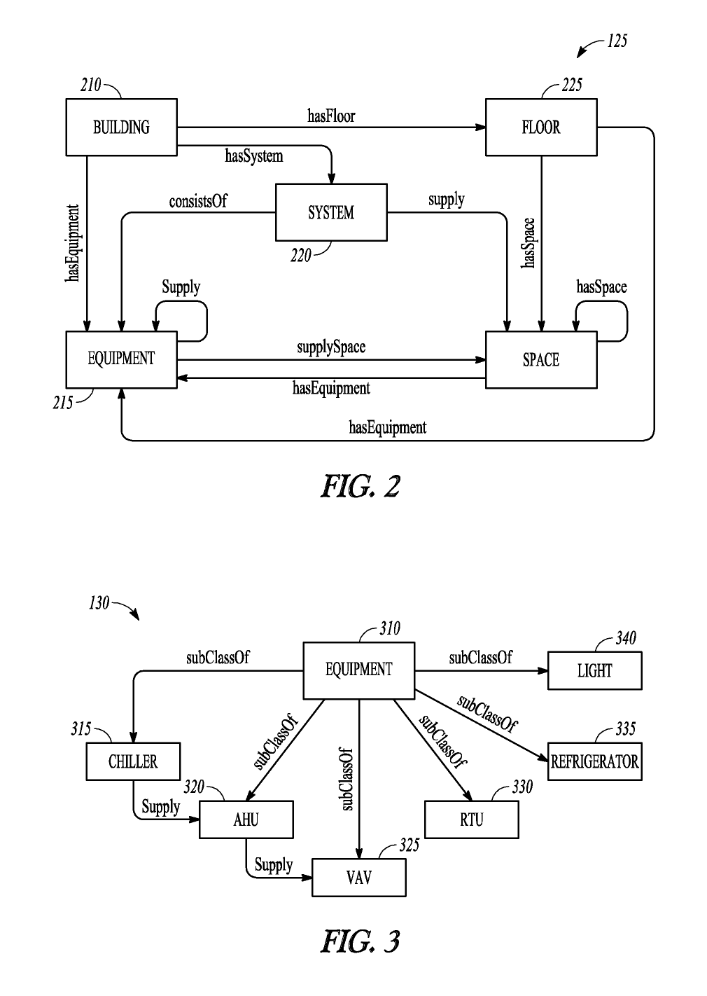

FIG. 2 is a diagram representation of a building ontology 125. Nodes illustrated in the ontology are composed of classes and objects. A building node 210 is coupled to an equipment node 215, system node 220, and floor node 225. A space node 230 is also illustrated, along with several interconnections between the nodes, each indicating a relationship between the nodes or a property of the nodes.

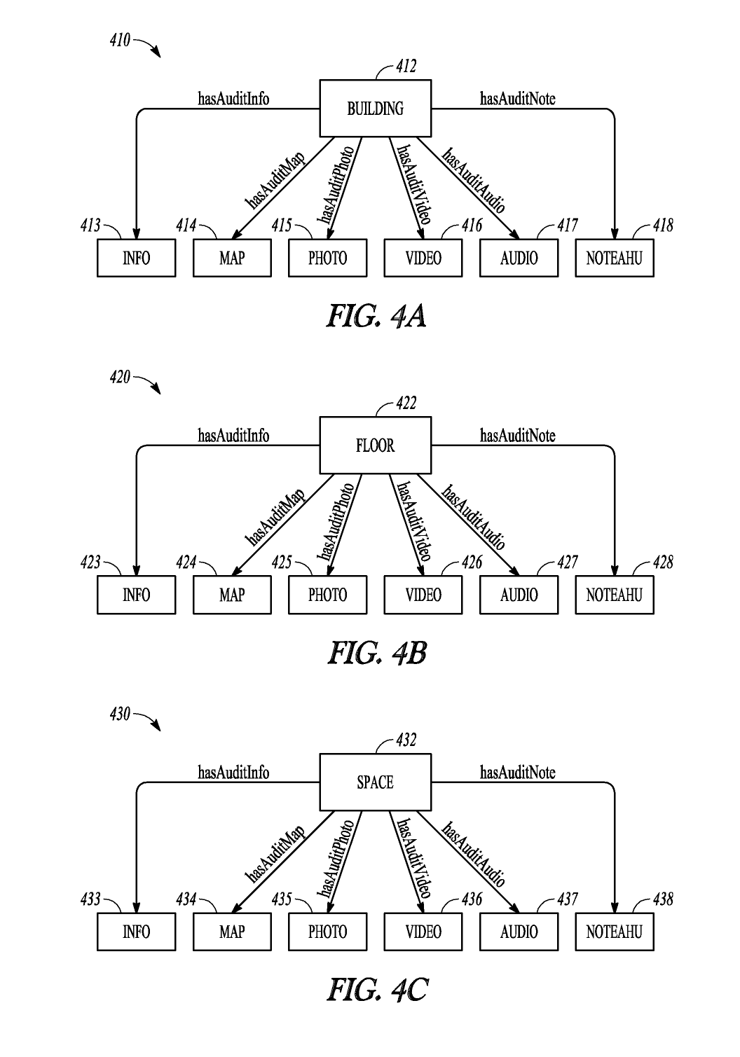

FIG. 3 is a diagram representation of an equipment ontology 130. An equipment node 310 is coupled to a chiller node 315, AHU node 320, VAV node 325, TRU node 330, refrigerator node 335, and light node 340. Connections between the nodes are indicated as supply, or subclass, indicative of a relationship or property between the nodes.

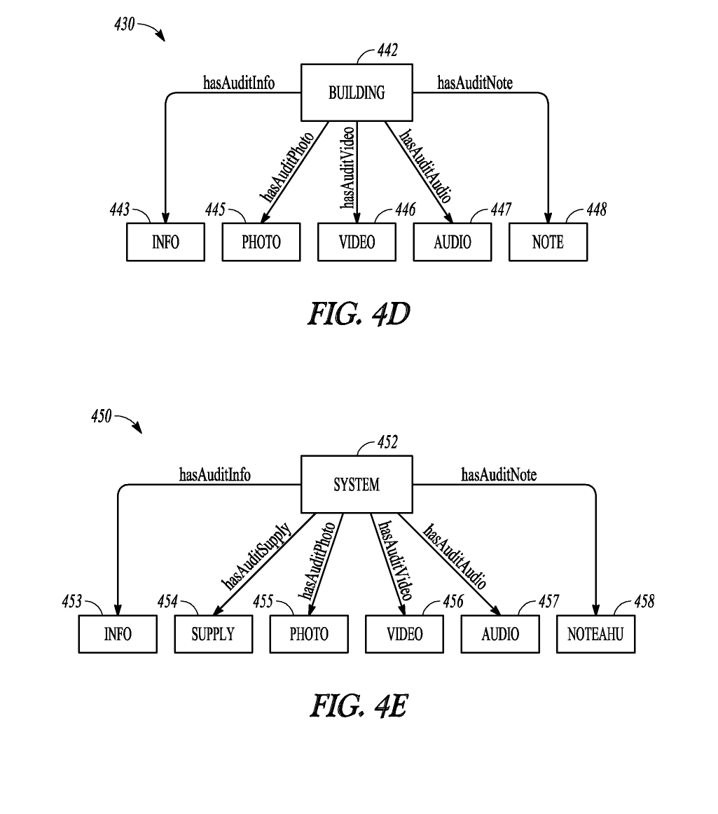

FIGS. 4A, 4B, 4C, 4D, and 4E are diagrams representing an audit ontology at 410, 420, 430, 440, and 450 respectively. Audit ontology 410 in FIG. 4A includes a building node 412, info node 413, map node 414, photo node 415, video node 416, audio node 417, and note node 418. These nodes are adapted to organize information in a format corresponding to their names in one embodiment. Audit ontology 420 in FIG. 4B includes a floor node 422, info node 423, map node 424, photo node 425, video node 426, audio node 427, and note node 428. Audit ontology 430 in FIG. 4C includes a space node 432, info node 433, map node 434, photo node 435, video node 436, audio node 437, and note node 438. Audit ontology 440 in FIG. 4D includes an equipment node 442, info node 443, photo node 445, video node 446, audio node 447, and note node 448. Ontology node 450 in FIG. 4E includes a system node 452, info node 453, supply node 454, photo node 455, video node 456, audio node 457, and note node 458.

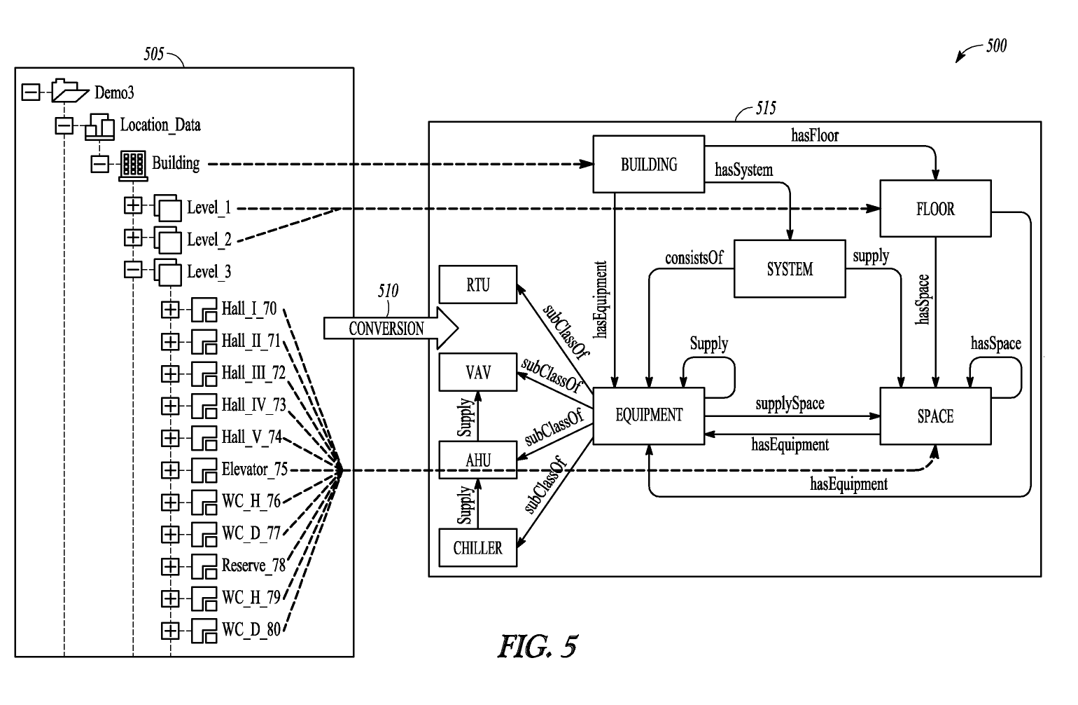

An example input conversion to convert data stored in a folder based format is illustrated at 500 in FIG. 5. Data 505 relating to a building is illustrated as stored in a hierarchical folder based format. The data undergoes a conversion at 510 where data is extracted from the folders and placed into corresponding nodes in a building ontology 515. The representation in FIG. 5 describes a meta-model for equipment systems. Therefore, the apparently self-referential relationship called “Supply” on the Equipment object should be read to mean that “any instance of any type of equipment as defined by the ontology may have a “Supply” relationship to a plurality of other equipment in the system. In rare cases, an equipment may have a supply relationship to itself.

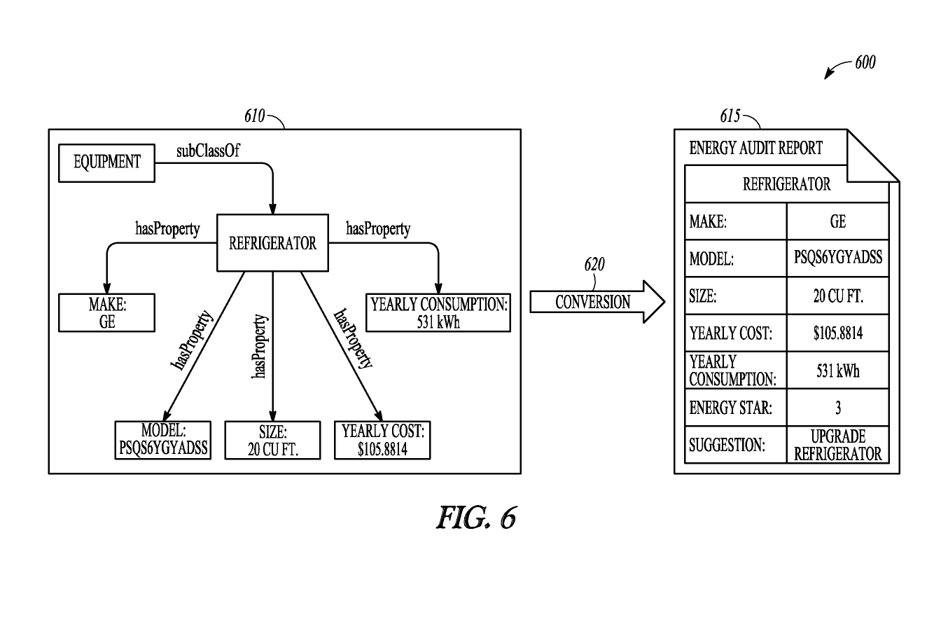

An example of output conversion is illustrated at 600 in FIG. 6. An equipment ontology 610 may be retrieved from the database 115 and transformed into an energy audit report 615 following conversion 620 of the data to a format that can be easily utilized by analytic programs to generate the report. In this example, the equipment is a refrigerator, and the audit report reflects the cost of operation and consumption. A suggestion to upgrade the refrigerator is also included in the report 615.

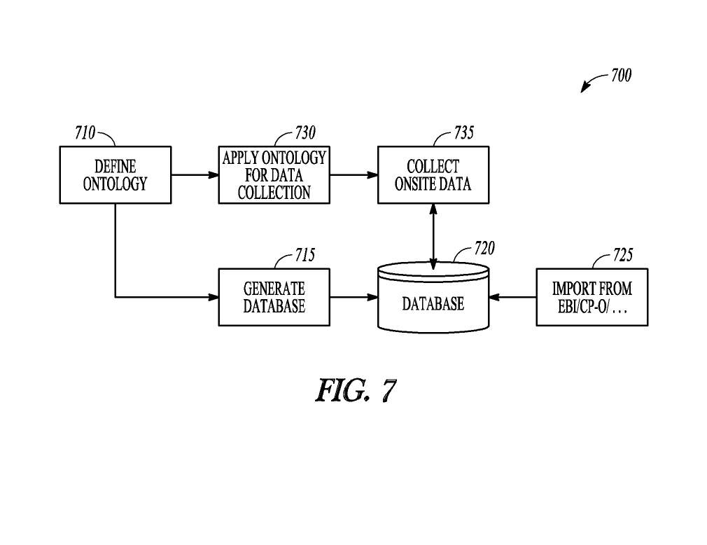

A data collection methodology is illustrated at 700 in flowchart form in FIG. 7. At 710, the ontology is defined for a building for example. At 715, the ontology is used to generate a database 720 consisting of instances of objects in the ontology. At 725, data may be imported into the instances from external systems. At 730, the defined ontology may be used adapt a data collection tool for use by auditors when performing audits, as indicated at 735, where onsite data is collected and provided to instances in the database 720. The methodology and ontology may thus be used to collect data from different sources.

A building audit tool may be used for data collection. The tool may be easy to use for different audit tasks, and may have one or more of the following features: Data collection from different data sources: existing data and on-site audit; specific data collection mechanism for different audit data; Simplified data collection for Audit based on ontology definition; and Heuristic data collection portal to create the instance of structured audit data, such as hierarchical data and sibling data.

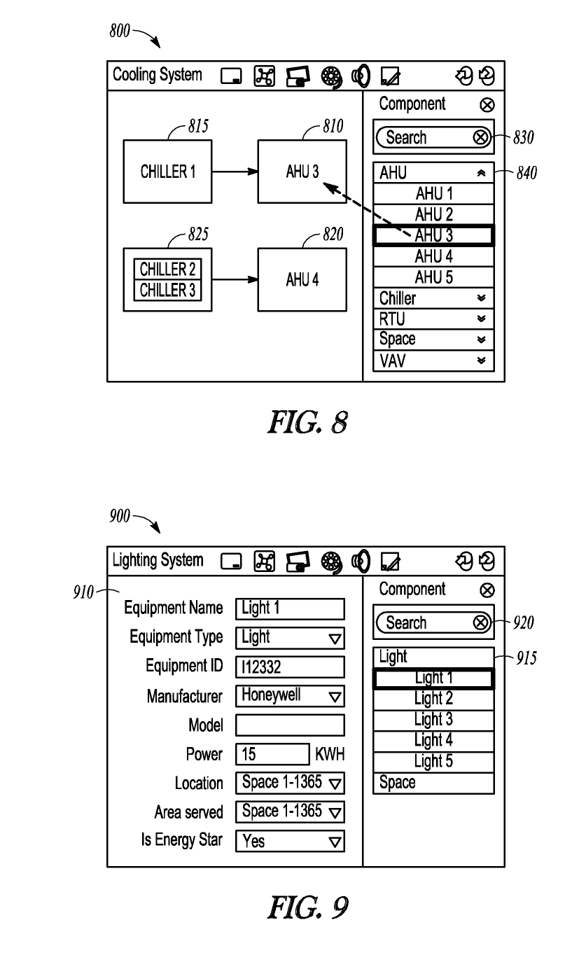

A data collection interface for an HVAC audit is illustrated at 800 in FIG. 8. A portion of the ontology is illustrated in graphic form on the left hand side of this example interface screen. In this ontology, an air handling unit, AHU 3 shown at 810 is associated with a chiller 815. Similarly, AHU 4 at 820 is shown associated with chiller 1 and chiller 2 at 825. The right hand side of the interface screen illustrates a component search field 830, and a list of components to select from at 840. Various pull down lists are illustrated with different types of components, allowing easy navigation through the audit ontology.

According to the audit ontology defined before, the system provides specific data collection mechanism for each specific audit task. The data collection mechanisms greatly simplify users' work and improves the interaction experience.

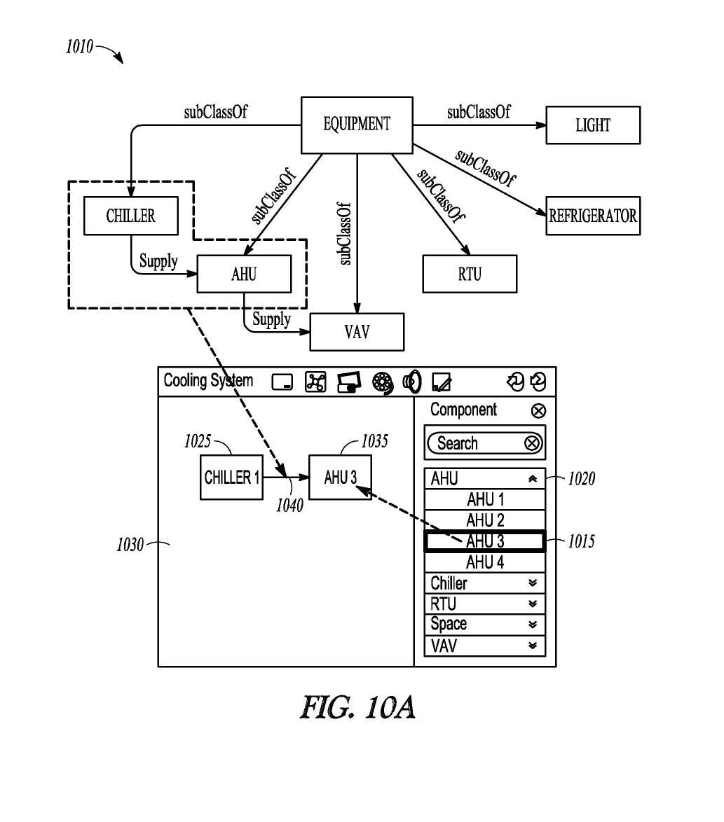

For example, for the HVAC system, the system will list all the equipment at 840 composing the system. The auditor may drag the equipment together and generate the supplying relationship automatically according to the ontology. An interface 900 for a lighting system audit is illustrated in FIG. 9. The audit system may provide a table 910 for the user to input the audit information during the walk-through audit. Again, a list of components 915 provides an easy interface from which to select components. Light 1 is shown as selected in the list 915 and also reflected in the data entry table 910. A search function 920 may also be provided in interface 900. In both interfaces 800 and 900, icons are provided for different types of media and data input mechanisms consistent with the corresponding audit ontologies.

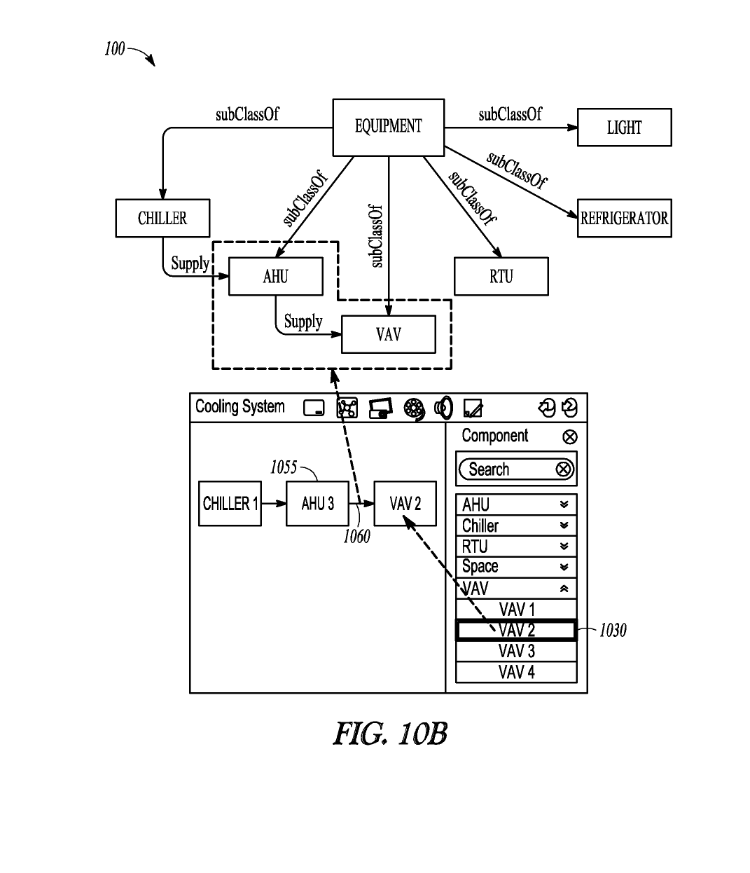

Predefined relationships in an ontology make data collection simple for a user as reflected in an HVAC audit interface example illustrated at 1000 in FIGS. 10A and 10B. In the HVAC audit interface example 1000, the relationship among the equipment of the HVAC is defined in an ontology 1010, so the user may drag a description of a piece of equipment, AHU 3 at 1015 from a list 1020, to another piece of equipment, chiller 1 at 1025 in a graphical display portion 1030 of the interface. The chiller 1025 is shown as connected to AHU 3 at 1035 via a relationship representation 1040. The relationship between the two pieces of equipment will be built automatically in the ontology as indicated at broken line 1045. This greatly simplifies users' work and improves the interaction experience. At 1050, a VAV 2 is selected from the list and dragged to AHU 3 indicated at 1055 in the graphical portion of the interface, resulting in a connection 1060 shown in the interface and reflected in the ontology at broken line 1065.

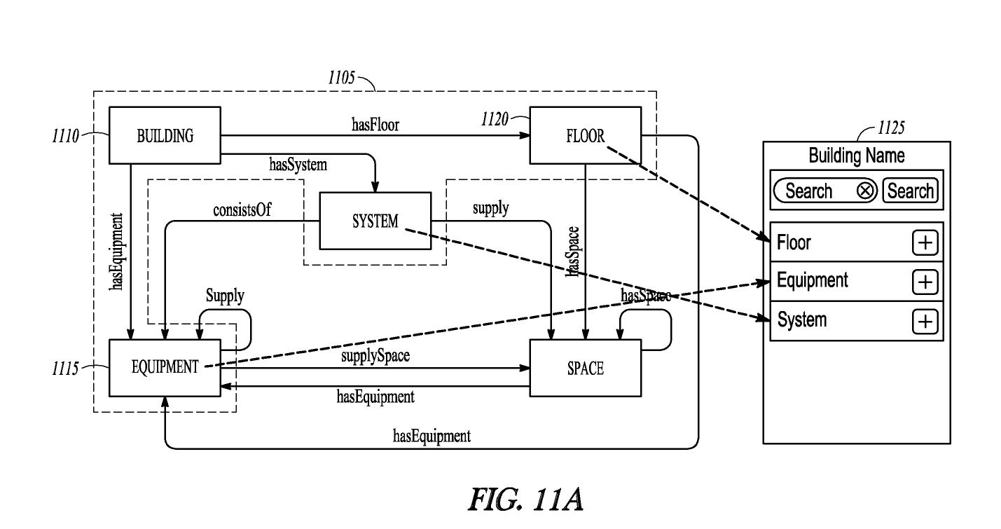

In order to collect data, a mechanism is provided for a user to create ontology instances. From a predefined ontology, a mechanism to input the data of different types, such as hierarchical data and sibling data may be generated. One rule to create a hierarchical data instance may be based on a condition that a concept has a relationship whose name contains “has”. Once such relationships are identified in the ontology, a portal may be provided for a user to create instances of children. Several occurrences of such a relationship is shown in an ontology 1105 in FIG. 11A, where a building node 1110 is shown with several “has” relationships with equipment 1115, system 1120, and floor 1125. Thus, the concept of building has three related relationships: hasFloor, hasEquipment, hasSystem. When a new building is created by user, the system generates three portals at 1125 for the inputting of “Floor”, “Equipment” and “System”

The concept of floor has two related relationships as shown at broken line 1130 in FIG. 11B: hasSpace, hasEquipment. When a new floor is created by user, the system should generate two portals at 1135 for the inputting of “Space” and “Equipment”.

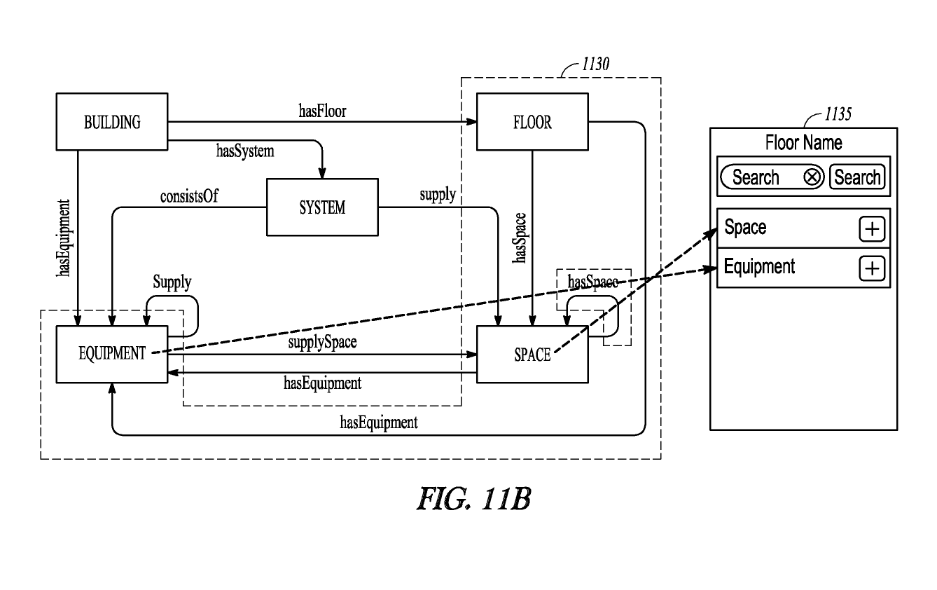

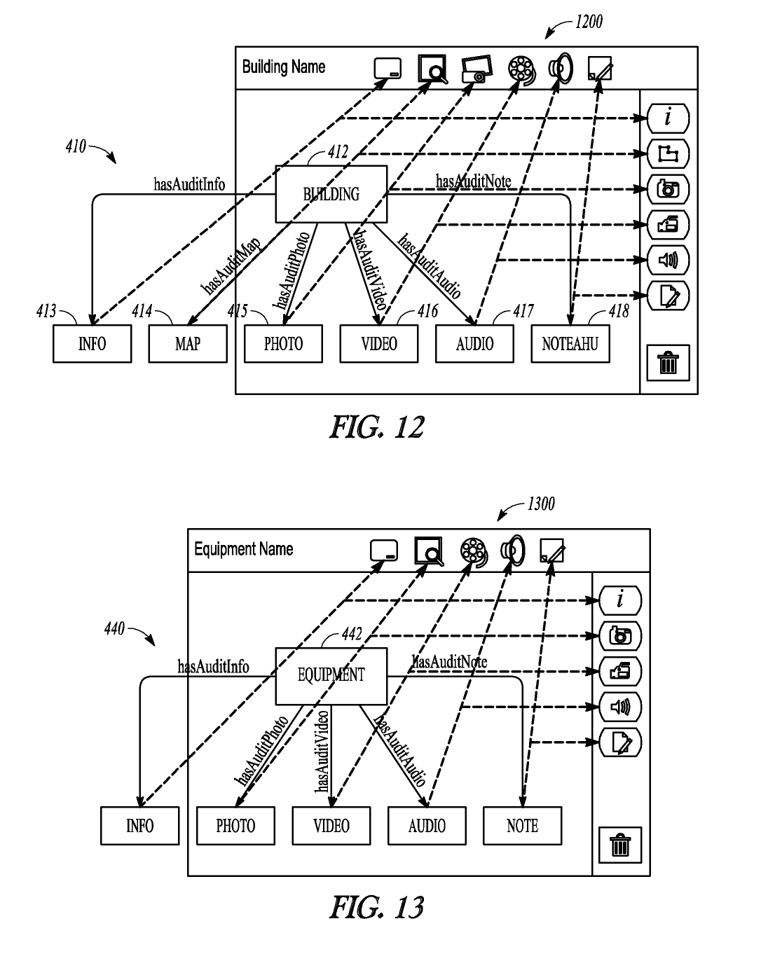

Given an audit ontology, sibling instance data may be created when a concept has a relationship whose name contains “hasAudit” in the audit ontology. The portals may be generated for viewing and importing the instance of the audit data of the concept. Examples are shown in FIGS. 12 and 13 for a building and a piece of equipment respectively at 1200 and 1300. In FIG. 12, the building audit ontology 410 is the same as that shown in FIG. 4. The concept of a building has six related relationships: hasAuditlnfo, hasAuditMap, hasAuditPhoto, hasAuditVideo, hasAuditAudio, hasAuditNote. When a building is selected by a user, there may be six icons in a top area of the interface, so that user can switch to show different kinds of audit information. There will also be seven buttons in right area, so that user can execute Add/Edit/Delete operation to different kinds of audit information.

Similarly, in FIG. 13, the equipment audit ontology 440 includes the concept of equipment 442 has five related relationships: hasAuditlnfo, hasAuditPhoto, hasAuditVideo, hasAuditAudio, hasAuditNote. When a piece of equipment is selected by user, there may be three icons in a top area, so that users can switch to show different kinds of audit information. There will also be four buttons in right area, so that users can execute Add/Edit/Delete operation to different kinds of audit information. It should be noted that the locations for various elements of the interfaces described are simply for example, and that actual locations may be varied and selected for further interfaces.

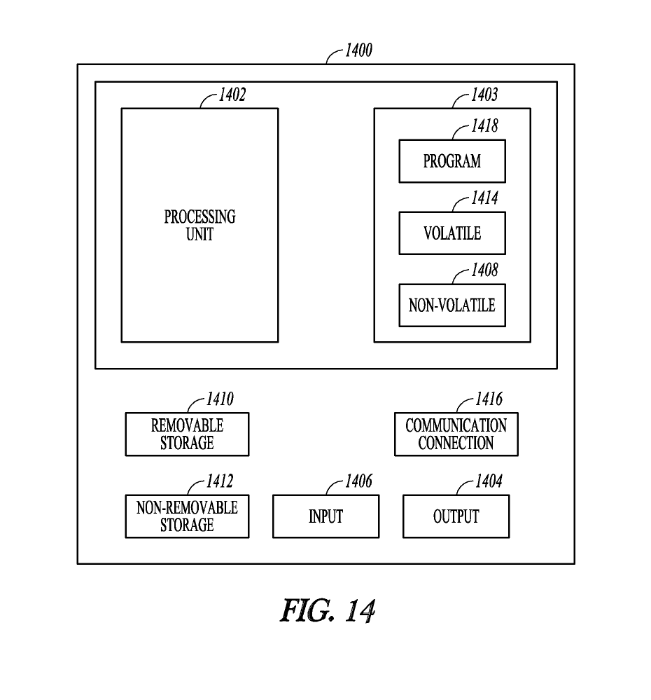

FIG. 14 is a block schematic diagram of a computer system 1400 to implement an audit system according to an example embodiment. In one embodiment, multiple such computer systems are utilized in a distributed network to implement multiple components in a transaction based environment. An object-oriented, service-oriented, or other architecture may be used to implement such functions and communicate between the multiple systems and components. One example computing device in the form of a computer 1400, may include a processing unit 1402, memory 1403, removable storage 1410, and non-removable storage 1412. Memory 1403 may include volatile memory 1414 and non-volatile memory 1408. Computer 1400 may include—or have access to a computing environment that includes—a variety of computer-readable media, such as volatile memory 1414 and non-volatile memory 1408, removable storage 1410 and non-removable storage 1412. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Computer 1400 may include or have access to a computing environment that includes input 1406, output 1404, and a communication connection 1416. The computer may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 1402 of the computer 1400. A hard drive, CD-ROM, and RAM are some examples of articles including a non-transitory computer-readable medium. For example, a computer program 1418 capable of providing a generic technique to perform access control check for data access and/or for doing an operation on one of the servers in a component object model (COM) based system may be included on a CD-ROM and loaded from the CD-ROM to a hard drive. The computer-readable instructions allow computer 1400 to provide generic access controls in a COM based computer network system having multiple users and servers.

### EXAMPLES

1. A method comprising:

representing a building structure and component systems using a structural set of ontologies to create a building ontology;
representing audit tasks and audit processes using an audit ontology; and presenting an ordered set of audit tasks to an auditor using the structural set of ontologies and the audit ontology, enabling the auditor to complete an audit process and populate data about instances in the building ontology representing a specific building.

2. The method of example 1, wherein the instance objects are pre-populated from existing sources through an import process.

3. The method of example 2 whereby one of the existing data sources is a Building Information Model including the physical relationships and spatial geometry of the environment and items to be audited.

4. The method of example 3, wherein the spatial geometry of the environment is used to guide the auditor to the location of the next item to be audited.

5. The method of any of examples 3-4 and further comprising generating a presentable report is accessible via a wireless portable computing device based on the populated data.

6. The method of example 5, whereby the report provides a human user a status of the auditable items and a status of audit tasks to be completed.

7. The method of any of examples 3-6 and further comprising:

providing a map of auditable components in a user interface, based on the spatial geometry of the building;
facilitating selection of an auditable component through interaction with the map; and
presenting audit entry fields for data collection for the auditable component.

8. The method of example 7, wherein the map is a 2D floor plan of the subject building

9. The method of any of examples 7-8, wherein the map is a 3D model of the subject building.

10. The method of any of examples 3-9, and further comprising facilitating addition of different types of audit information.

11. The method of any of examples 1-10, wherein the collected data is exportable to other applications and presentable in a report.

12. The method of any of examples 1-11, wherein the ordered set of tasks are defined by one or more specific ontologies with specific scope that limits an audit context.

13. The method of any of examples 1-12 wherein the building ontology includes classes and objects representative of a building, floors in the building, and space in the building, and wherein the classes and objects are coupled by relationships including a relationship of hasfloor between the building and a floor, and a relationship of hasspace between a floor and a space.

14. The method of any of examples 1-13 wherein the ontology includes classes and objects representative of a building, equipment in the building, and systems in the building, wherein an equipment object has a set of relationships with other equipment objects.

15. A computer readable storage device having instructions for causing a computer to perform a method, the method comprising:

representing a building structure and component systems using a structural set of ontologies to create a building ontology;
representing audit tasks and audit processes using an audit ontology;
presenting an ordered set of audit tasks to an auditor using the structural set of ontologies and the audit ontology, enabling the auditor to complete an audit process and populate data about instances in the building ontology representing a specific building.

16. The computer readable storage device of example 15, wherein the method further comprises:

providing a map of auditable components in a user interface, based on the spatial geometry of the building;
facilitating selection of an auditable component through interaction with the map; and presenting audit entry fields for data collection for the auditable component.

17. The computer readable storage device of any of examples 15-16, wherein the method further comprises:

providing a map of auditable components in a user interface, based on a spatial geometry of the building represented in the building ontology;
facilitating selection of an auditable component through interaction with the map; and
presenting audit entry fields for data collection for the auditable component.

18. A system comprising:

a building ontology representing a building structure and component systems using a structural set of ontologies stored on a computer readable storage device;
an audit ontology representing audit tasks and audit processes stored on a computer readable storage device;
a processor coupled to access the audit ontology, and having code for executing an audit tool, the audit tool stored on a computer readable storage device and comprising code to present an ordered set of audit tasks to an auditor using the structural set of ontologies and the audit ontology, enabling the auditor to complete an audit process and populate data about instances in the building ontology representing a specific building.

19. The system of example 18 wherein the audit tool further comprises code to facilitate addition of different types of audit information.

20. The system of any of examples 18-19 wherein the building ontology includes classes and objects representative of a building, floors in the building, and space in the building, and wherein the classes and objects are coupled by relationships including a relationship of hasfloor between the building and a floor, and a relationship of hasspace between a floor and a space.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
representing a building structure and component systems using a structural set of ontologies to create a building ontology;
representing audit tasks and audit processes using an audit ontology; and
presenting an ordered set of audit tasks to an auditor using the structural set of ontologies and the audit ontology, enabling the auditor to complete an audit process and populate data about instances in the building ontology representing a specific building.

2. The method of claim 1, wherein the instance objects are pre-populated from existing sources through an import process.

3. The method of claim 2 whereby one of the existing data sources is a Building Information Model including the physical relationships and spatial geometry of the environment and items to be audited.

4. The method of claim 3, wherein the spatial geometry of the environment is used to guide the auditor to the location of the next item to be audited.

5. The method of claim 3 and further comprising generating a presentable report is accessible via a wireless portable computing device based on the populated data.

6. The method of claim 5, whereby the report provides a human user a status of the auditable items and a status of audit tasks to be completed.

7. The method of claim 3 and further comprising:
providing a map of auditable components in a user interface, based on the spatial geometry of the building;
facilitating selection of an auditable component through interaction with the map; and
presenting audit entry fields for data collection for the auditable component.

8. The method of claim 7, wherein the map is a 2D floor plan of the subject building

9. The method of claim 7, wherein the map is a 3D model of the subject building.

10. The method of claim 3, and further comprising facilitating addition of different types of audit information.

11. The method of claim 1, wherein the collected data is exportable to other applications and presentable in a report.

12. The method of claim 1, wherein the ordered set of tasks are defined by one or more specific ontologies with specific scope that limits an audit context.

13. The method of claim 1 wherein the building ontology includes classes and objects representative of a building, floors in the building, and space in the building, and wherein the classes and objects are coupled by relationships including a relationship of hasfloor between the building and a floor, and a relationship of hasspace between a floor and a space.

14. The method of claim 1 wherein the ontology includes classes and objects representative of a building, equipment in the building, and systems in the building, wherein an equipment object has a set of relationships with other equipment objects.

15. A computer readable storage device having instructions for causing a computer to perform a method, the method comprising:
representing a building structure and component systems using a structural set of ontologies to create a building ontology;
representing audit tasks and audit processes using an audit ontology;
presenting an ordered set of audit tasks to an auditor using the structural set of ontologies and the audit ontology, enabling the auditor to complete an audit process and populate data about instances in the building ontology representing a specific building.

16. The computer readable storage device of claim 15, wherein the method further comprises:
providing a map of auditable components in a user interface, based on the spatial geometry of the building;
facilitating selection of an auditable component through interaction with the map; and
presenting audit entry fields for data collection for the auditable component.

17. The computer readable storage device of claim 15, wherein the method further comprises:
providing a map of auditable components in a user interface, based on a spatial geometry of the building represented in the building ontology;
facilitating selection of an auditable component through interaction with the map; and
presenting audit entry fields for data collection for the auditable component.

18. A system comprising:
a building ontology representing a building structure and component systems using a structural set of ontologies stored on a computer readable storage device;
an audit ontology representing audit tasks and audit processes stored on a computer readable storage device;
a processor coupled to access the audit ontology, and having code for executing an audit tool, the audit tool stored on a computer readable storage device and comprising code to present an ordered set of audit tasks to an auditor using the structural set of ontologies and the audit ontology, enabling the auditor to complete an audit process and populate data about instances in the building ontology representing a specific building.

19. The system of claim 18 wherein the audit tool further comprises code to facilitate addition of different types of audit information.

20. The system of claim 18 wherein the building ontology includes classes and objects representative of a building, floors in the building, and space in the building, and wherein the classes and objects are coupled by relationships including a relationship of hasfloor between the building and a floor, and a relationship of hasspace between a floor and a space.
